(19) United States
(12) Patent Application Publication
(10) Pub. No.: US 2006/0228483 A1
(43) Pub. Date: Oct. 12, 2006

(54) Method of producing membranes for filtration modules which are intended, for example, for water treatment

(75) Inventor: Nouhad Abidine, Donneville (FR)

Correspondence Address: CONNOLLY BOVE LODGE & HUTZ LLP, SUITE 800, 1990 M STREET NW, WASHINGTON, DC, 20036-3425, US

(73) Assignee: AQUASOURCE, TOULOUSE (FR)

(21) Appl. No.: 10/543,693

(22) PCT Filed: Jan. 26, 2004
(86) PCT No.: PCT/FR04/00174

§ 371 Date: Mar. 16, 2006

(30) Foreign Application Priority Data
Jan. 29, 2003 (FR) 03/01013

(51) Int. Cl. B05D 1/40

(52) U.S. Cl. 427/331

(57) ABSTRACT

The invention relates to a method of producing membranes for nanofiltration, ultrafiltration or microfiltration modules which are intended, for example, for water treatment, said membranes comprising a hydrophobic polymer material having a hydrophilic polymer material incorporated therein or deposited thereon. The invention is characterised in that it comprises the following steps consisting in: (a) cold conditioning the membrane, following the incorporation or deposition of the hydrophilic polymer material, in a solution containing ammonium, sodium or potassium persulphate; and (b) hot crosslinking the hydrophobic and hydrophilic polymer materials forming the membrane, at a temperature greater than 60 DEG C, by soaking said membrane in a crosslinking agent employing a radical mechanism.

The present invention relates to the manufacture of membranes for nanofiltration, ultrafiltration or micro-filtration modules, especially for water treatment, said membranes consisting of two polymers, firstly a hydrophobic polymer material, and secondly a hydrophilic polymer material, these two polymers being “alloyed” together.

Membranes based on hydrophobic materials, used in the field of water treatment, have the advantage of being chemically, thermally and bacteriologically stable; however, they are subject to rapid and irreversible clogging with the matter in suspension and/or the organic matter present, in particular in surface waters. The use of membranes of this type is possible, but requires frequent chemical washing, which complicates the exploitation of the plants, increases the exploitation cost and reduces the productivity of the filtration system.

Membranes based on hydrophilic polymer are less subject to clogging and are thus of major interest from the point of view of “factory production management”. Generally, such membranes are characterized by productivity that is very much higher than that of hydrophobic membranes, this productivity resulting from their chemical nature, which itself conditions the potential level of clogging of these membranes. Their main drawback lies in the fact that they are subject to faster chemical aging and have a potential risk of bacteriological degradation, in particular for membranes based on cellulose derivatives. This last parameter is not a technological barrier, since it is possible to take operating precautions to satisfactorily protect the membranes against the risk of impairment caused by bacteria.

Numerous membrane modification studies have already been published, which are directed toward producing a membrane based on a hydrophobic material into which is incorporated (or onto which is deposited) a hydrophilic material. In general, it is sought to give the novel membrane better clogging behavior without compromising the mechanical properties or affecting the integrity of the membranes thus modified (P. Rouzies, thesis, UPS Toulouse, Mar. 11, 1992, K. Asfardjanie and thesis, USP Toulouse, Jul. 12, 1991). However, all the advantages of the hydrophilic properties thus provided to the membranes proved to be transient and became weaker as a function of the filtration time and of the cumulative effect of the applied washes.

EP-A-0 568 045 describes a process for manufacturing hollow fibers intended for the blood dialysis process and developed using polysulfone (PSF). To do this, a formulation based on PSF and hydrophilic and pore-forming agents is used. However, this publication does not teach any chemical treatment capable of fixing or stabilizing the hydrophilic agent in the membrane: experience shows that in this case, as in many others, the hydrophilizing agent is progressively eluted from the membrane (F. Ivaldi, thesis, UPS Toulouse, Dec. 15, 1982).

U.S. Pat. No. 5,543,465 is directed toward stabilizing polyvinylpyrrolidone (PVP), as hydrophilizing agent, within the porous structure of the membrane. In order to permanently fix the hydrophilic nature of the membrane resulting from the introduction of said PVP, this publication refers to various examples in which PVP is fixed into a PSF matrix, by first conditioning the raw membrane in a rinsing liquid containing PVP, and then crosslinking it by chemical treatment using a free-radical crosslinking agent, potassium persulfate. However, on account of the high level of PVP recommended (between 0.5% and 10% by weight), the process described leads to a large reduction in the water permeability of the membrane. Table 1, a summary of tests at increasing concentration, given herein-below, clearly shows the effect of the concentration of PVP in the rinsing water on said water permeability (Lp).

TABLE 1
Effect of the concentration of PVP K30
on the final water permeability of type A fibers

| | | | |
|---|---|---|---|
| C_{PVP}, mass % | 0 | 0.1 | 0.5 |
| 10⁻¹⁰ m/s · Pa | 11.9 | 4.2 | 1.1 |

In any case, the addition of PVP or of hydrophilic agent to the PSF or hydrophobic polymer substrate should be limited, failing which the permeability is appreciably reduced in the event of an excessive proportion of said hydrophilic agent in the polymer blend.

To illustrate the prior art in this field, mention may also be made of U.S. Pat. No. 4,798,847, EP-A-0 261 734 and U.S. Pat. No. 5,076,925, which describe processes for manufacturing membranes in which a thermal crosslinking of PVP is described. However, as described in patent U.S. Pat. No. 2,658,045 and in the publication by Anderson (Journal of Applied Polymer Sciences, 23, 2453-2462, 1979), the PVP fixing method indicated in these publications cannot ensure the stability of the performance qualities of the fibers over time. The reason for this is that these publications use intensive rinsing processes (going up to the use of organic extraction solvents), such processes being directed toward removing the “pore-forming” fraction of the PVP, while leaving in place only the PVP close to the molecules of the support polymer; the crosslinking of these molecules will therefore not give rise to any reduction in the water permeability of the membranes thus treated. This thermal treatment process to crosslink PVP is thus insufficient, since it gives rise to a fragile and unstable gel.

Starting from this prior art, the present invention set itself the objective of manufacturing a membrane consisting of an “alloy” of two polymers: simple chemistry, making it possible, with the proviso of using appropriate controls and processes to ensure the cohesion of these two polymer materials so that this results in, for said membrane, an advantageous combination of the properties of the two constituent polymers.

Consequently, the invention relates to a process for manufacturing membranes for filtration modules, especially for water treatment, comprising a hydro-phobic polymer material to which is incorporated, or onto which is deposited, a hydrophilic polymer material, characterized in that it comprises the following steps:

a) the membrane is conditioned, without heating, after incorporation or deposition of the hydrophilic polymer material, in a solution containing potassium, sodium or ammonium persulfate, and

b) hot crosslinking is performed, at a temperature above 60° C. and preferably of about 70 to 80° C., of the hydrophilic and hydrophobic polymer materials constituting the membrane, by dipping said membrane into a crosslinking agent acting via a free-radical mechanism, especially an aqueous persulfate solution.

According to the present invention, one of the two polymers may be a simple molecule capable of being split by the action of a crosslinking agent acting via a free-radical mechanism. According to one embodiment of the process of the invention, the crosslinking between the hydrophobic and hydrophilic polymer materials is performed with heating by the action of a sodium persulfate solution with a concentration of between 2 and 7 g/l. According to the invention, prior to the crosslinking step, the raw membrane is dipped without heating into an aqueous sodium persulfate solution having a mass concentration of between 2 and 7 g/l, for 2 to 24 hours and preferably 4 to 12 hours.

In order for the subject of the present invention to be clearly understood, the studies that enabled its development will first be described.

The Proprietor first undertook two actions, in order to more clearly understand the role of the persulfate radical on the PSF and PVP molecules. It thus attempted to check whether or not potassium persulfate acts on polysulfone alone. To do this, prerinsed hollow fibers were dipped into a mixture containing 0.5% and 5.0% of persulfate at high temperature (90° C.) for one hour. It was then demonstrated that the mechanical performance of these fibers diminished, in relation with the persulfate concentration (see table 2 below). There is thus no doubt that the persulfate radicals do indeed attack the polymer chains, such as polysulfone.

TABLE 2
Action of the persulfate radical on the mechanical
performance of PSF-based fibers

| | | | |
|---|---|---|---|
| C_{persulfate}, mass % | 0 | 0.5 | 5 |
| Breaking force, N | 6.9 | 6.5 | 4.6 |
| Elongation at break, % | 34 | 22 | 5.8 |

The mode of action of persulfate on the crosslinking of PVP was also successfully elucidated, thus confirming the results published by Anderson, in the publication Journal of Applied Polymer Sciences, and by U.S. Pat. No. 2,658,045 cited above, namely that the crosslinking of PVP requires a high concentration of said PVP, in the presence of a high concentration (a few mass %) of persulfate. However, in order to maintain the permeability of the “finished” membrane, it is necessary to limit both the concentration of PVP in the PSF and the persulfate concentration.

Finally, the validity of the heating cycle proposed by Anderson, ie that the activity of the persulfate radicals occurs from a temperature above 60° C. and increases gradually up to 90° C., was checked. An important phenomenon was thus discovered: the reactivity of potassium persulfate is gradual from 60° C. and becomes increasingly rapid by increasing the temperature. It was also seen that this activity already exists at a lower temperature, 40° C., and that it is nonexistent at room temperature. Table 3 below illustrates these observations.

TABLE 3
Change in the concentration of persulfate ion,
expressed as % of moles converted into radical as a
function of the temperature and the test time
(CO = 1% by mass, solvent: ultrapure water)

| | Contact time, hours | | |
|---|---|---|---|
| Temperature, ° C. | 1 h | 2 h | 3 h |
| 20 | 0 | 0 | 0 |
| 40 | 0 | 0 | 0.6 |
| 60 | 4.6 | 8.1 | 9.4 |
| 80 | 29.6 | 45 | 52.3 |
| 90 | 16.5 | 57.1 | 69.4 |

Two important comments must be made at this stage:
at room temperature, the persulfate ion remains stable (the ions present in the solution were assayed over about thirty hours, without observing any change), whereas at and above 40° C., the persulfate ion begins to be converted into persulfate radical after only 3 hours, but very few ions are concerned, only 0.6%;
the increase in temperature accelerates the conversion of the persulfate.

The process that is the subject of the invention makes it possible to conserve the control of the relative proportions of the two polymers, on one side of the membrane (“outer skin”) or on the other (“inner skin”), or even on both sides; specifically, a rapid reduction in temperature makes it possible to block the crosslinking process when needed.

One embodiment of the process that is the subject of the invention is given below. This embodiment, given purely as a nonlimiting example, includes the following steps:

A) introduction of the hydrophilic polymer material: it is preferable for this agent to be in the closest possible contact with the hydrophobic polymer. It is thus generally introduced into the base formulation used to make the membranes, so as to ensure intimate and homogeneous distribution;

B) when the hydrophilic material is introduced into the base formulation, the membranes are carefully rinsed before crosslinking with the persulfate, in order to remove as much as possible the hydrophilic products included in the pore volumes of the membrane;

C) conditioning, without heating, of the membrane in a solution containing potassium, sodium or ammonium persulfate. In this manner, these ions will be propagated, by natural diffusion, throughout the porous structure. This step is necessary in order to ensure the homogeneity of the treatment according to the following step;

D) crosslinking by hot dipping, at a temperature above 60° C. and preferably from about 70 to 80° C., of the membranes in an aqueous persulfate solution. The persulfate should be added to hot water, immediately before dipping the fibers, so as not to preferentially cause the formation of radicals that might then react prematurely with the hydroxyl ions of the water. In conjunction with the concentration of the persulfate ions, the time and temperature of this treatment will condition the power of the free-radical action of these ions;

E) emptying of the reservoir containing the membranes, which allows the crosslinking reaction to be blocked quickly by means of the rapid reduction in the temperature of the membranes resulting from this emptying; F) rinsing of the membranes, for example by soaking in hot water. This soaking may be performed at a temperature of between 60 and 90° C., for 1 to 24 hours and preferably for 2 to 12 hours. These conditions, and also the composition of the rinsing liquid, may be modified, especially in order to obtain “purified” membranes for hospital or medical use. In this case, the rinsing liquid may consist of a mixture of water and ethanol, in order to reinforce the extraction power of the rinsing water;

G) final conditioning of the membranes in a mixture containing water and glycerol, only in the case where it is necessary to dry the membranes in order to bond them (for example in the case of the “potting” of hollow fibers).

The process that is the subject of the invention allows the manufacture of membranes within the porosity range from nanofiltration (or lower limit of ultrafiltration) up to the upper limit of microfiltration. In order to increase the content of hydrophilic material, starting with a given percentage of said material, it is preferable to use a hydrophilic material of higher molecular mass in order to minimize the amount required to give the membrane the intended filtration performance. Similarly, the more the hydrophilic material is compatible with the hydrophobic support polymer, the greater will be the stabilization of this hydrophilic material in the matrix of the support polymer, in particular in the dense matrix in which the various polymers coexist.

Practical examples of implementation of the process described above are given hereinbelow, these examples allowing the advantages provided by the present invention to be understood.

In these examples, only the cases of PSF-based membranes into which PVP has been incorporated as hydrophilic agent have been described. In all these examples, the permeability values are those at 20° C.

### EXAMPLE 1

The collodion used consists of:

| | |
|---|---|
| PSF grade S 6010 = | 18% |
| PEG-1500 extrusion additive | about 15-25% |
| PVP K30 = | 2% |
| N-methylpyrrolidone | qs 100%. |

After dissolution by mechanical stirring at 80° C. for 24 hours, this collodion is filtered through a stainless-steel gauze with a filtration threshold of close to 10 μm, and then degassed under vacuum. A hollow fiber with outside/inside diameters of 1.8/1.0 mm is produced. To precipitate the fiber, an internal liquid and an identical external liquid are used, comprising from 5% to 50% as mass ratio of N-methylpyrrolidone, preferably 25% to 40% for the fibers with an inner skin; to produce fibers with an outer skin, the percentage of solvent should be between 40% and 100% and preferably between 50% and 90%. The collodion, the inner liquid and the outer liquid are maintained at a temperature of between 20 and 60° C. and preferably 25 to 45° C. during the precipitation of the fiber. The fiber obtained initially has a water permeability equal to 8.6×10⁻¹⁰ m/s. Pa, a breaking force of 9.5 newtons and an elongation at break of 50%. After soaking in water supplemented with 1000 ppm of chlorine, the water permeability of the fibers is measured, and is equal to 9.7×10⁻¹⁰ m/s. Pa.

The “raw extrusion” fibers, without soaking in chlorine, are rinsed in water for 24 hours and then soaked in an aqueous solution containing 3 g/l of potassium persulfate, for a period of between 2 and 24 hours and preferably 4 to 12 hours. They are then treated in an aqueous solution containing 3 g/l of the same persulfate, maintained at 70° C. for about 30 minutes. These fibers are rinsed by static soaking in hot water (80° C. for 5 hours) and are then conditioned in an aqueous glycerol solution (60% by mass). Before conditioning in the mixture containing glycerol, the mechanical tensile properties of the fibers were characterized. The breaking force and the elongation at break of the fibers are measured here. They are, respectively, equal to 9.6 N and 35%. The fibers are then air-dried for two days. Despite this treatment using a free-radical agent, a large part of the mechanical performance of the fibers was able to be maintained, and only the elongation at break of the fiber was decreased. However, this decrease in the elongation is due firstly to the better removal of pore-forming agent and of hydrophilic agent that has not been attached onto or in the fibers, and secondly to the creation of new chemical bonds between the various polymer chains forming the fibers.

A control performed on a micro-module, after thorough rinsing of the fibers, shows that the content of residual fixed PVP of the polymerized fiber is equal to 4.5%. The fiber contained 10% of PVP, relative to the dry matter originally present in the collodion. This thus ensures that the process maintains PVP macromolecules fixed in the polysulfone matrix.

### EXAMPLE 2

In this example, the same “raw extrusion” fiber as that of example 1 was reproduced, to which was then applied rinsing with water containing 0.1% of PVP K30. The water permeability of the fiber was also measured at 6.9×10⁻¹ m/s. Pa (instead of 9.7-10×10⁻¹⁰ m/s. Pa obtained previously). The use of this fiber, in a module equipped with 1 m² of filtering area, in the filtration of Seine water does not make it possible to obtain functionally stable permeability, even for an operating flow equal to 1.7×10⁻¹⁰ m/s. Pa.

Throughout all the filtration tests that were performed, the major characteristics of the Seine water were similar to the values indicated in table 0.4 below:

TABLE 4

| Parameters | Mean values |
|---|---|
| pH | 7.6-8.2 |
| Iron concentration, μg/l | <200 |
| Mn concentration, μg/l | <50 |
| Turbidity, NTU | <50 |
| | (usually <10 and a few |
| | peaks at 200) |
| UV absorbance, m⁻¹ | <6 |
| Total organic carbon, mg/l | <5 |

The filtration mode was always in frontal regime. The filtration cycles lasted 30 minutes. The washing of the fibers was performed by back-washing with permeate supplemented with 5 ppm of chlorine and lasted 1 to 2 minutes. The back-washing ensured the inverse filtration of 8.3 to 9.7×10⁻⁵ m/s of permeate under a maximum set pressure of 2.5×10⁵.

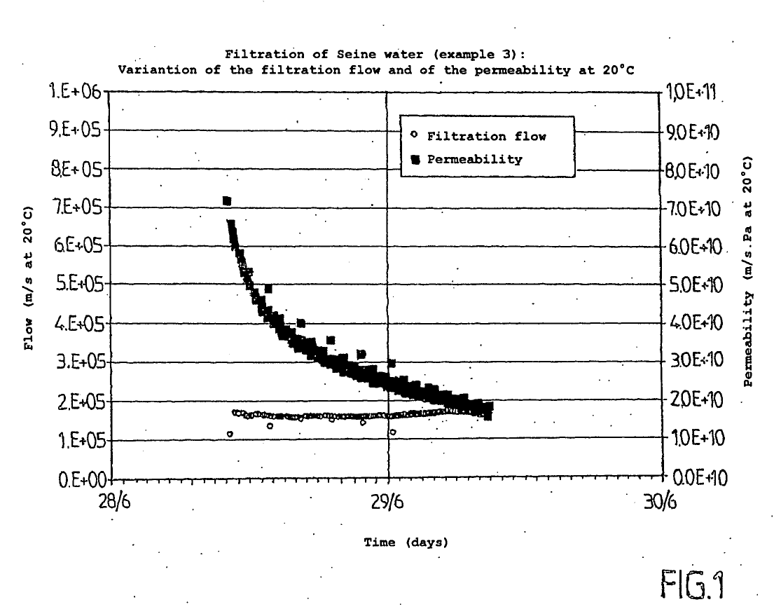

FIG. 1 of the attached drawings shows the change in the permeability of the membranes during a filtration of Seine water having the characteristics specified in table 4. It is noted that after 2 days of use, the water permeability falls to 60 l/h·m²·bar and chemical washing becomes necessary in order to return the fibers to their initial water permeability.

### EXAMPLE 3

Relative to the conditions of example 1, only the quality of the PVP present in the collodion is changed. For this example, a K 25 “grade” PVP is used, of lower molecular mass than in the preceding example (ie about 30 000 instead of 60 000 daltons). The same series of tests is performed. Finally, the following overall performances are measured:

Fiber dimension: D_{outside}/D_{inside}=1.78/1.02 mm

Initial permeability: 5.3×10⁻¹⁰ m/s. Pa

Breaking force: 7.7 N

Elongation at break: 62%

Crosslinking is performed by soaking the fibers in a solution containing 5 g/l of potassium persulfate, first without heating for 24 hours, and then at 80° C. for 30 minutes. After rinsing, conditioning in glycerol and rewetting with water, the performance values of the fibers are measured; these values changed in the following manner:

Breaking force: 7.8N

Elongation at break: 37%

Water permeability: 9.4-11.4×10⁻¹⁰ m/s. Pa

It is seen herein that this treatment only modifies the elongation at break of the fiber. The increase in the water permeability is obtained by virtue of the better removal of PVP from the PSF matrix. The breaking force of the fiber changed very little.

The elemental analysis shows a percentage of PVP close to 2.5%. The amount of PVP attached in the fiber is thus reduced and the water permeability of the fiber is higher than in example 2.

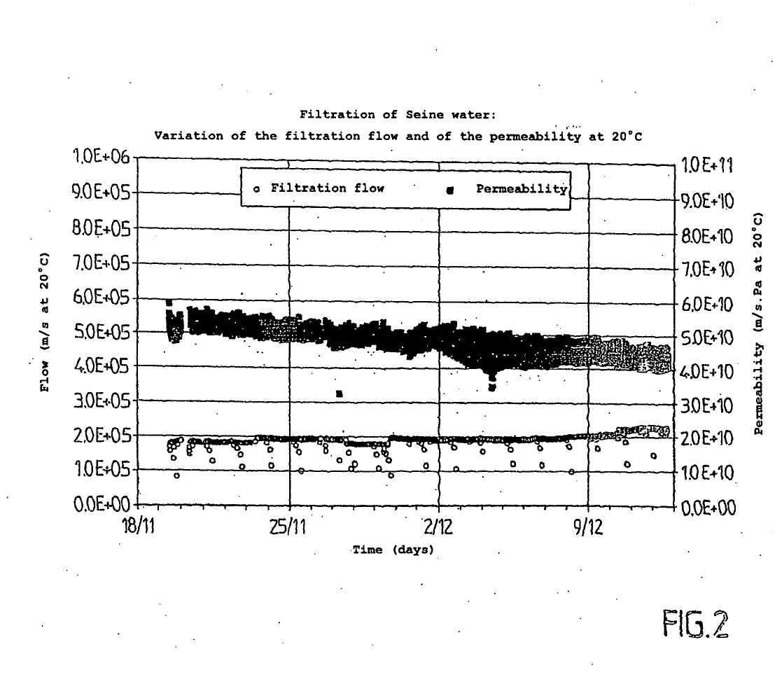

FIG. 2 of the attached drawings shows the change in the permeability of the membranes during filtration of a Seine water having the characteristics specified in table 4. During these tests, a module equipped with a filtration area of 1 m² was produced, and its permeability at the end of manufacture was equal to 9.7×10⁻¹⁰ m/s. Pa. This module was then placed in continuous filtration of the Seine water, starting by applying a production flow equal to 1.9×10⁻⁵ m/s.

Examination of this FIG. 2 shows that the water permeability of the fibers quite quickly fell from 11.1 to 5.0-5.55×10⁻¹⁰ m/s. Pa, but it was found, surprisingly, that it decreased very slowly over time. On the 12th day of filtration, the stabilized permeability remained close to 4-5×10⁻¹⁰ m/s. Pa. The flow was then increased to 2.2×10⁻⁵ m/s and it was confirmed over 5 consecutive days that this change did not affect the stability of the permeability of the fibers.

Thus, the process that is the subject of the present invention allows the manufacture of membranes that maintain their hydrophilic nature and that acquire novel additional performance, optimizing their use or broadening their fields of application. In particular, by means of the process that is the subject of the invention, it is possible to maintain over time the characteristics acquired by the membranes during the various steps of the process described above.

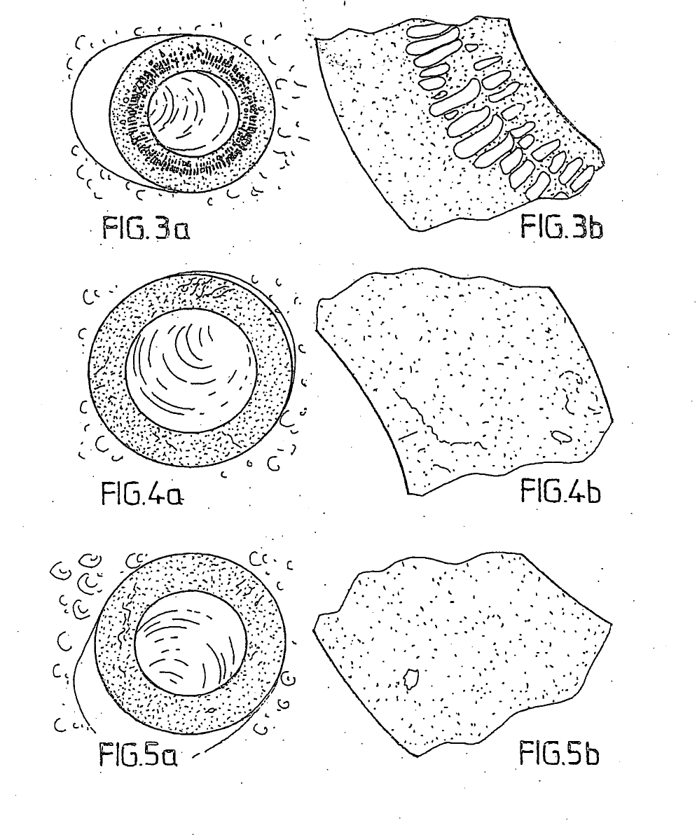

FIGS. 3a to 5b are photographs that were obtained using a scanning electron microscope, and illustrate the porous structure of the membrane fibers produced in accordance with the process that is the subject of the invention.

Depending on the operating conditions, the fibers do or do not comprise vacuoles (see the detail of the cross section of the fibers on these photographs), and may also be in the form of a homogeneous structure. The important feature is that the vacuoles possibly present do not come into contact with the skin of the membrane, which must remain supported by a homogeneous structure.

FIG. 3a shows a cutaway view of the fiber: this is a standard structure of PSF-based fibers.

FIG. 3b illustrates a detail of the cross section of the fiber: an inner skin, a spongy porous structure containing vacuoles, and then an outer skin are seen therein.

FIGS. 4a to 5b are cutaway views that illustrate the cross section of fibers not containing vacuoles.

It is clearly understood that the present invention is not limited to the implementation examples described and represented above, but rather encompasses all the variants.

1. A process for manufacturing membranes for nanofiltration, ultrafiltration or microfiltration modules especially for water treatment, comprising a hydrophobic polymer material to which is incorporated, or onto which is deposited, a hydrophilic polymer material, characterized in that it comprises the following steps:
a) the membrane is conditioned, without heating, after incorporation or deposition of the hydrophilic polymer material, in a solution containing potassium, sodium or ammonium persulfate, and
b) hot crosslinking is performed, at a temperature above 60° C., of the hydrophilic and hydrophobic polymer materials constituting the membrane, by dipping said membrane into a crosslinking agent acting via a free-radical mechanism.

2. The process as claimed in claim 1, wherein one of said polymers is a simple molecule capable of being split by the action of said crosslinking agent acting via a free-radical mechanism.

3. The process as claimed in claim 1, wherein the crosslinking agent acting via a free-radical mechanism is an aqueous persulfate solution.

4. The process as claimed in claim 1, wherein the crosslinking between the hydrophobic and hydrophilic polymer materials is performed with heating by the action of a sodium persulfate solution with a concentration of between 2 and 7 g/l.

5. The process as claimed in claim 1, wherein, prior to the crosslinking step, the raw membrane is subjected to soaking without heating, in an aqueous sodium persulfate solution with a mass concentration of between 2 and 7 g/l, for 2 to 24 hours and preferably 4 to 12 hours.

6. The process as claimed in claim 1, wherein the hot crosslinking is performed at a temperature of about 70 to 80° C. for about 30 minutes.

7. The process as claimed in claim 1 wherein, prior to the conditioning and crosslinking step, the raw membranes are rinsed with water.

8. The process as claimed in claim 1, wherein the crosslinking reaction is blocked by means of a rapid reduction of the temperature of the membranes, after the crosslinking step.

9. The process as claimed in claim 1 wherein, after the crosslinking step, the membranes are rinsed.

10. The process as claimed in claim 9, wherein the rinsing of the membranes is performed with hot water, at a temperature of between 60 and 90° C. and for 1 to 24 hours and preferably for 2 to 12 hours.

11. The process as claimed in claim 10, wherein the rinsing water is supplemented with ethanol.

12. The process as claimed in claim 1, wherein it includes a step of final conditioning of the membranes in an aqueous glycerol solution, when the membranes require drying, followed by bonding.

13. The process as claimed in claim 1, wherein the hydrophobic polymer material is polysulfone.

14. The process as claimed in claim 1, wherein the hydrophilic polymer material is polyvinylpyrrolidone
